(19) United States
(12) Patent Application Publication
(10) Pub. No.: US 2024/0290045 A1
(43) Pub. Date: Aug. 29, 2024

(54) AUGMENTED REALITY METHODS FOR PERSONNEL, AND METHODS TO QUANTIFY PERFORMANCE ENHANCEMENT

(71) Applicant: LabLightAR Inc., Seattle, WA (US)

(72) Inventors: Roger BRENT, Seattle, WA (US); Nik STIRES, Seattle, WA (US); J. Anthony MEIN, Seattle, WA (US); Karrington OGANS, Seattle, WA (US); James ASHLEY, Lilburn, GA (US); Jasper BREKELMANS, Amsterdam (NL); Roland SMEENK, Ede (NL)

(21) Appl. No.: 18/586,404

(22) Filed: Feb. 23, 2024

Related U.S. Application Data
(60) Provisional application No. 63/447,848, filed on Feb. 23, 2023.

(51) Int. Cl. G06T 19/00; G06Q 10/0639

(52) U.S. Cl. CPC G06T 19/006; G06Q 10/06398

(57) ABSTRACT

Methods, systems, and apparatus, including computer programs encoded on a computer storage medium, for implementing augmented reality and quantify performance enhancement are disclosed. In one aspect, a method includes the actions accessing a protocol that specifies a procedure to be performed by an operator wearing an AR/MR/XR device. The actions further include generating instructions to assist the operator wearing the AR/MR/XR device in performing the procedure. The actions further include outputting the instructions. The actions further include receiving sensor data that reflects characteristics of an environment where the operator wearing the AR/MR/XR device is located. The actions further include determining whether the operator is performing the procedure correctly. The actions further include generating feedback to assist the operator wearing the AR/MR/XR device in determining whether to adjust actions being performed by the operator in performing the procedure. The actions further include outputting the feedback.

### CROSS-REFERENCE TO RELATED APPLICATION

This application claims the benefit of U.S. Application No. 63/447,848, filed Feb. 23, 2023, which is incorporated by reference.

### BACKGROUND

Augmented, Mixed, or eXtended Reality (AR/MR/XR) may be described as the superimposition, via the user's sensorium, of entities made of information (made of bits) upon entities in the physical world (made of atoms). The development of workable “strong” AR/MR/XR devices, such as the first and second generation HoloLens and the Magic Leap One and Two, demonstrates that there is now hardware to accomplish this task. The abilities this hardware enables may eventually revolutionize, e.g., laboratory work and the like that require that people operate on or in response to information, and also on physical objects. Put more generally, strong AR/MR/XR devices may enable presentation of content providing procedural guidance of particular utility for workers who spend much of their time interacting with objects in the physical world, for example by using their hands. However, current AR/MR/XR provides, at most, only part of the ability needed to realize these and other goals.

### DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example context diagram that provides an overview of augmented reality (AR) methods for personnel and methods to quantify performance enhancement.

FIG. 2 illustrates the laboratory work environment, specifically the operator at her bench, in greater detail.

FIG. 3 is a contextual diagram of an IPG System.

FIG. 4 describes an environmental diagram that includes an exemplary hardware, software, and communications computing environment.

FIG. 5 illustrates an exemplary process for carrying out augmented reality-guided methods as described herein.

FIG. 6 is a flowchart of another exemplary process for carrying out augmented reality-guided methods.

### DETAILED DESCRIPTION

Many of the most compelling imagined uses of AR/MR/XR, including the provision of procedural guidance, require particular abilities that current headsets do not have. These include, without limitation, one or more of a) ability to identify or support identification of physical objects, b) ability to determine, with high resolution and accuracy, the localization, or location, of physical objects in the physical world, c) ability to determine, with high spatial resolution and accuracy, orientation (attitude or pose) of objects in the physical world, d) ability to keep track of physical objects as they move or are moved through the physical world and change pose over time, e) ability to generate high resolution, accurately spatially positioned and posed virtual objects in the user's sensorium, and adjust their location, pose, and shape over time, and f), that, ideally, the ability of the AR system to “understand” the work environment and the work task at hand.

Some of the above functionalities also have utility in VR. These include, without limitation, identification and accurate determination of location and attitude of objects in the physical world (for example, the user's hands) in order to direct the localization and orientation of objects reified in the virtual world.

One reason current AR/MR devices cannot support these functions is that their ability to resolve and localize physical and virtual objects is only accurate within a few centimeters, while their ability to identify, track, and determine pose for physical objects are not supported at all. One consequence of this spatial inaccuracy and the other shortcomings of current AR/MR devices is that these devices cannot localize physical and virtual objects the size of screws, switches, knobs, or fingertips, and thus cannot provide guidance for procedures operating on objects of similar or smaller scales. These same limitations on spatial localization and precise determination of pose apply to VR devices in those instances where applications in VR localize and determine pose of objects in the physical world and use that information to generate objects or actions in the virtual world.

A second limitation of current and envisioned AR/MR/XR devices for applications including procedural guidance is that, since object identification and tracking are not carried out by the headsets, it is sometimes envisioned that the additional processing to carry out these two functions will be carried out not locally, but in the cloud. However, computation in the cloud introduces latency. It also carries with it security risks: that information and processing carried out in the cloud will be accessible to the cloud service providers, this information and processing might be breached by third parties, and information passing to and from the cloud might be intercepted.

A third limitation of current and envisioned AR and MR devices for applications including procedural guidance is that off-device computation supporting object identification, object tracking, and determination of object pose can be carried out by deep neural networks trained to recognize individual objects and object classes, rather than using computational analytical geometry or other deterministic machine vision approaches. These networks have some disadvantages. For example, they can be frail when presented with data not represented in their training data. Another is that, due to the inscrutability of deep neural networks, it is difficult to impossible to troubleshoot errors made by the trained networks and correct those errors.

Microtiter plates or microplates, are used throughout biological R and D, in production environments (such as genome sequencing facilities), and in biological manufacture. 8×12 or 96-well plates, and also 384 and 1536 well plates, are used for essentially every biochemical or cell-based bioassay. For each assay that uses a microtiter plate, critical reagents must be carefully loaded into individual wells in the plate in complex patterns of serial additions of liquid. Some plate loading is done by robots/liquid handling systems. Such systems can be programmed to load the plates for the most stereotypic and highest throughput cases, but those have systems have high capital and maintenance costs and are often idled by breakdowns. For that reason, across industry and academia, everyday assays with differing sample numbers or varied reaction conditions are individually designed and loaded by human operators' hand held micropipets. This pipetting process is simultaneously tedious and attention-demanding, and so is highly prone to errors that can invalidate expensive assays.

For these and other reasons, it is useful for AR/MR and VR devices to carry out the following functions: a) identify and support identification of physical objects, b) carry out spatially accurate, high resolution localization of physical objects, c) carry out spatially accurate, high resolution determination of orientation (attitude or pose) of physical objects, d) track physical objects as they move or are moved through space and change pose over time, and e) generate high resolution, accurately spatially positioned and posed virtual objects and adjust their location, pose, and shape over time.

For some of the envisioned uses of AR/MR/XR, it may be desirable to carry out at least some of the computations supporting these functions locally, rather than in the cloud. In some examples, this can be done on a local computer, such as a laptop.

For some applications, including those for which troubleshooting might be desirable, it would be further helpful to: a) support object identification and b) determine object pose by analytical/computational methods rather than computational methods based on deep neural networks.

The present system both actively reduces error rates and documents successful microplate loading. A protocol may be input via a .csv file, typically generated by a spreadsheet, and system control can be carried out by a lab worker using voice commands, air gestures, and/or operations on virtual buttons and other affordances in in various embodiments. The system guides the operator for each process step and documents completion of each process step. By so doing, the guidance provided by the system reduces the cognitive burden on the lab worker—akin to the reduction of cognitive load for a vehicle driver who is navigating using spoken turn-by-turn guidance compared with that required for the driver to read a road map—and reduces errors, including those caused by operators losing place within the sequence through distraction or mental fatigue.

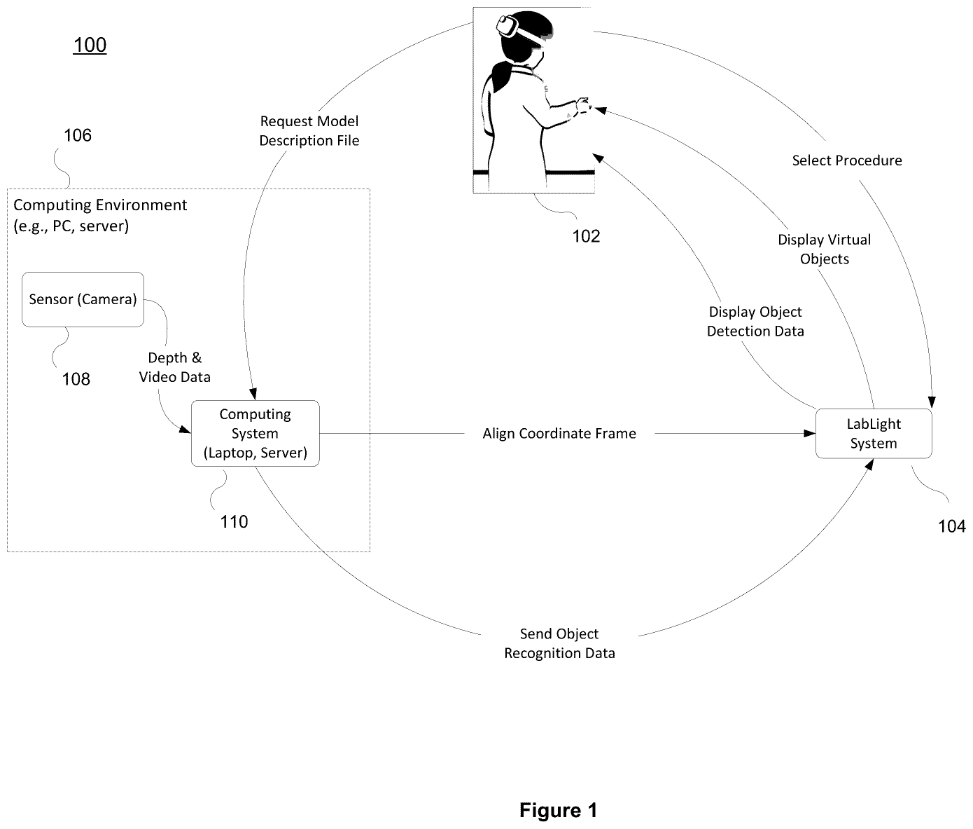

FIG. 1 illustrates an example context diagram 100 that provides an overview of augmented reality (AR) methods for personnel and methods to quantify performance enhancement. As shown in the example of FIG. 1, an operator 102 performs laboratory work using AR technology aided by a LabLight system 104, which may be comprised of one or more sensors, one or more computing systems (GPU laptops or desktops, servers, virtual machines in the cloud, or other computing entities), and/or one or more AR devices. In this example, the operator is loading a microtiter plate in an AR environment. In some embodiments, the AR environment may provide interactive procedural guidance, including but not limited to instructions, workflows, markers, data, metadata about any of these, as well as indicators and visual cues to aid the operations being performed, overlaid on the physical environment as viewed via a device, e.g., goggles, glasses, a headset, or contact lenses, configured to combine the virtual and physical environments. Many or all of these virtual overlays may be coordinated via a computing environment 106 that may include, among other things, a sensor 108 and a computing system 110.

In one example, the bench may be a site for loading wells of a microplate. Various equipment for the guided loading of the wells may include, without limitation, a pipetting device, tubes holding samples and reagents, and one or more tube holders, a microplate, a computing device such as a laptop, etc.

The computing environment 106 may include one or more sensors, represented here by a camera 108, and a computing system 110. The computing system 110 may include and/or be hosted on a laptop or server in some embodiments, but other suitable computing devices may be employed to achieve the ends described herein.

In some embodiments, the operator 102 may select a procedure to be carried out at the bench. For example, the operator 102 may select a pipetting procedure that involves transferring a reagent from a test tube to a well or wells in a microplate. The LabLight system 104 may include or support a computing device via which the operator 102 is instructed in the procedure, as well as monitored for correct (or incorrect) performance, in accordance with data or other information transmitted to and received from the computing system 110 and/or sensor 108. The sensor 108 may be configured to input the physical environment of the bench, the hands of the operator 102, and/or items in use by the operator 102, for example, and provide depth and video data to the computing system 110. The computing system may input the depth and video data and interpret information about the physical scene from the data. The computing system 110 can provide object recognition data to the LabLight system 104 and, in some instances, a coordinate frame or grid to align the microplate relative to the virtual environment. The computing system 110 may further load a model description file representing the configuration of the bench and its equipment. From the computing device, the LabLight system 104 may present to the operator 102 object detection data and virtual objects for display via the headset.

It should be noted that some or all functions of the LabLight system 104 and the computing system 110 may be performed by either apparatus. In some embodiments, the LabLight system 104 is relieved of many or most of the processing functions related to instructing the operator 102 and detecting feedback and results from the operator 102 and sensor 108, to reduce weight and battery power constraints, for example, and make the headset as “light” in terms of processing as possible. Another computing device or devices, not shown, can also be put into use for this purpose as well.

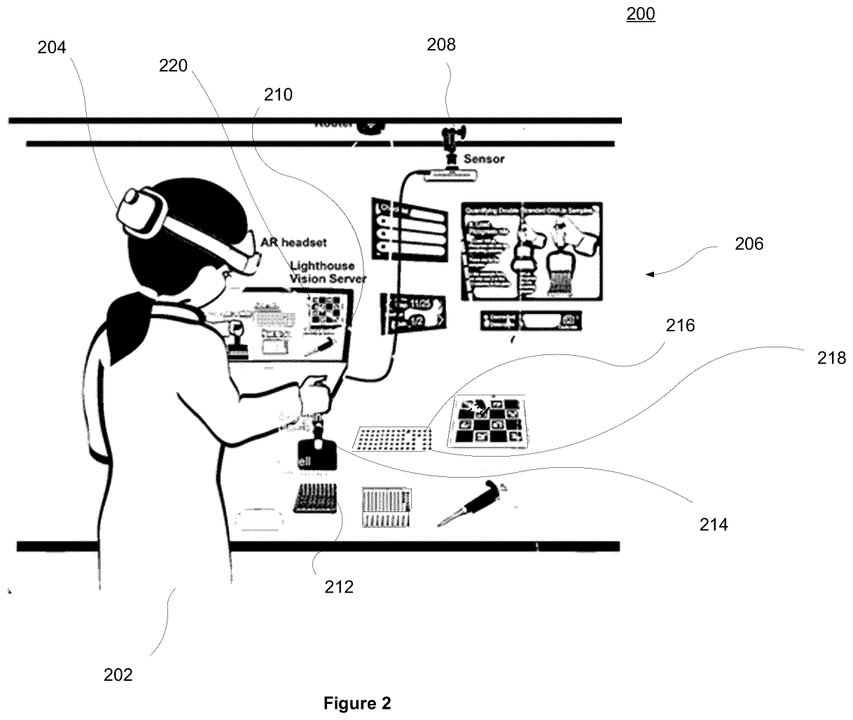

FIG. 2 illustrates the laboratory work environment, specifically the operator 202 wearing a headset as part of the LabLight system 204, in greater detail. The operator 202 and the LabLight system 204 may correspond to the operator 102 and LabLight system 104, respectively. As shown in FIG. 2, the operator 202 is engaged in drawing a reagent or other solution from a test tube 212 using a pipette or micropipette 214, and subsequently depositing the solution into wells 216. Notably, this disclosure is not limited to embodiments related to transferring solution from one location to another, or even transferring a substance from one location to another in general, but may also relate to techniques that include one or more of identifying a source or location of a subject matter, object, and/or device, identifying the subject matter, object, and/or device, identifying a process and/or operation to be performed with respect to the subject matter, object, and/or device, and performing the process and/or operation with guidance as described herein. That is, these techniques have a wider applicability than the specific embodiments described herein.

In a run-through to quantify performance enhancement, wells 216 were to be loaded with systematic combinations of high, medium and low fluorophore from different labeled tubes 212, and some wells 216 also loaded with an additional dose of medium fluorophore. Signal was measured at 530-540 nm in a Spectramax M fluorimeter after excitation at 485 nm. Raw fluorescence output was compared with normalized raw output, after expected fluorescence is subtracted. Wells 216 loaded with an extra dose of 10 AU of fluorophore were clearly apparent and automatically scored, and “mistake wells” that deviate by >3 AU from correct fluorescence, were also apparent and automatically labeled. In this case performance improved through feedback. Common pipetting errors included loading into wrong wells and failure to load into particular wells, which often stem from the operator 202 losing track of a previous action during a sequence of steps and inadvertently either duplicating a step or skipping a step.

Performance improvement via reduction in cognitive load using the disclosed system may be quantified by the methods described herein. These methods are generally applicable for determination of pipetting accuracy and steering development of these and other AR systems (for example in A/B tests) to allow determination of whether changes to the system, UI, etc. positively affect performance.

Some embodiments configure the system to import digital loading instructions (a “pipetting protocol”) as standard format file(s) (.csv and .xmlx, for example) that specify identities and amounts of reagents to be loaded into each well 216. Those may be generated in some instances by the spreadsheet software commonly used to program plates and relayed to the LabLight system 204 from the computing system 110, or from another source.

In some embodiments, the system may actively guide the operator 202 through the process of loading the wells 216. For example, in the operator's field of view, the system may localize or present a template 220 via the headset, allowing the operator 202 to localize the microplate 218. Then, the system may tell the operator about the well or wells 216 to be loaded by creating an object precisely positioned within the operator's field of view through the headset, such as an attention-grabbing marker plus information about the well (such as an identifying number), and indicates the tube of reagent to be loaded by presenting attention grabbing colored markers or other indicators over the tops of the tube.

In some embodiments, a voice recognition feature may permit active well-by-well confirmation of correct loading by the operator 202 speaking a voice command (for example, the word “check”). In other embodiments, computer vision may be employed in the base station that may see and understand when a pipet tip 214 inserted into a well 216 is withdrawn. Other ways of confirming step completion may include use of external devices, such as Bluetooth pipetting devices, a foot pedal that the operator 202 can activate each time a step is completed, etc. In a voice recognition embodiment, when the operator 202 utters the word “check”, a checkmark may appear to the operator 202, for example on a floating checklist visible to the operator 202 via the headset. In another example, the operator 202 may be played a sound evocative of checking to indicate that the operation was successfully performed and logged. In response to the confirmation, the configured system may “paint” the next tube 212 to be loaded and the next well 216 to be loaded together with redundant visual information in the visual field. In this manner, by loading wells and saying “check”, the operator 202 may step through each loading step of the protocol well by well.

In some embodiments, the operator can back up with a suitable gesture or action, such as by voicing the command “uncheck” whereby the well marker may move to the previous position, accompanied by a change in the well and test tube identifiers, or by a different sound, for example. On completion of the sequence of steps, the operator may utter the word “signoff” and the checklist (with time stamps for each step) may become locked. The operator may then proceed to the next process step (and checklist) by saying the word “Next”, and back up by saying the word “Previous”, by way of illustration. Each of these moves may be accompanied by a distinct tone and/or audio cue. Further, the entire process, or part thereof, may be captured by time-synced video from the overhead sensor 208 and/or from the AR headset. A final checklist file with or without the video can be linked to standard lab information management systems (LIMS) and Electronic Lab Notebooks (ELNs) to document success.

For illustration, the computing system 110 may provide one or more virtual cues presented via the headset to guide the operator 202 carrying out the procedure. For example, visual cues may indicate items to be used in carrying out the next step in the procedure, order of items to be used, a countdown timer, a clock showing time elapsed, information related to assay equipment or samples/reagents, and the like. For example, via the headset, and in accordance with the pipetting protocol, the operator 202 may be presented with a visual cue such as a colored dot pointing out the pipet tip 214, test tube 212, and well 216; the dot over the pipet tip 214 may flash until the system senses that the pipet tip has been grabbed by the pipetting device (or the operator 202 indicates that the pipet tip has been grabbed), then the dot over the next test tube 212 may flash until the system senses that a sample has been drawn from that test tube (or the operator indicates that the sample has been drawn), followed by the placement of a flashing dot over the well containing the reagent to indicate where the operator should deposit the sample, etc.

There are many examples of virtual cues that can be used. Moreover, virtual cues are not limited to visual cues; audio cues are also contemplated, for example spatially localizable tones that direct the operator's attention to the next object or location. Without limitation, some visual cues may include “painting” a source test tube with a particular color (to identify the liquid in that tube—consider a test tube containing a liquid with a high concentration of fluorescein, painted green). A pulsating sphere overlaid on a destination well A1 can indicate that the operator 102 should add 10 μL of liquid from that source tube to the destination well A1 (for this example, the pulsating sphere could be made green to match the green of the corresponding test tube). In this example, the pulsating virtual green sphere is used as a guide to the correct test tube. Other visual cues can be animations, assigned shapes, icons, sizes of the cues, colors or color changes, etc. Audible cues may be tones, buzzing, or other noises, distinguishable by frequency, tempo, volume, and/or changes in these as well as their location within the operator's field of hearing (FoH).

In at least one embodiment, after completing each procedural step, the operator 102 says “check”. A checkmark appears on the floating virtual checklist. The computing system then paints a marker over a second source tube, which contains a liquid with a medium concentration of some reagent. The computing system 110 places a pulsating blue sphere over the new destination well, B1. The operator repeats the above steps and keeps saying “check” until the loading procedure is finished for all wells to be loaded. The computing system 110 may record a time-stamped checklist synchronized with time-stamped video to document these actions.

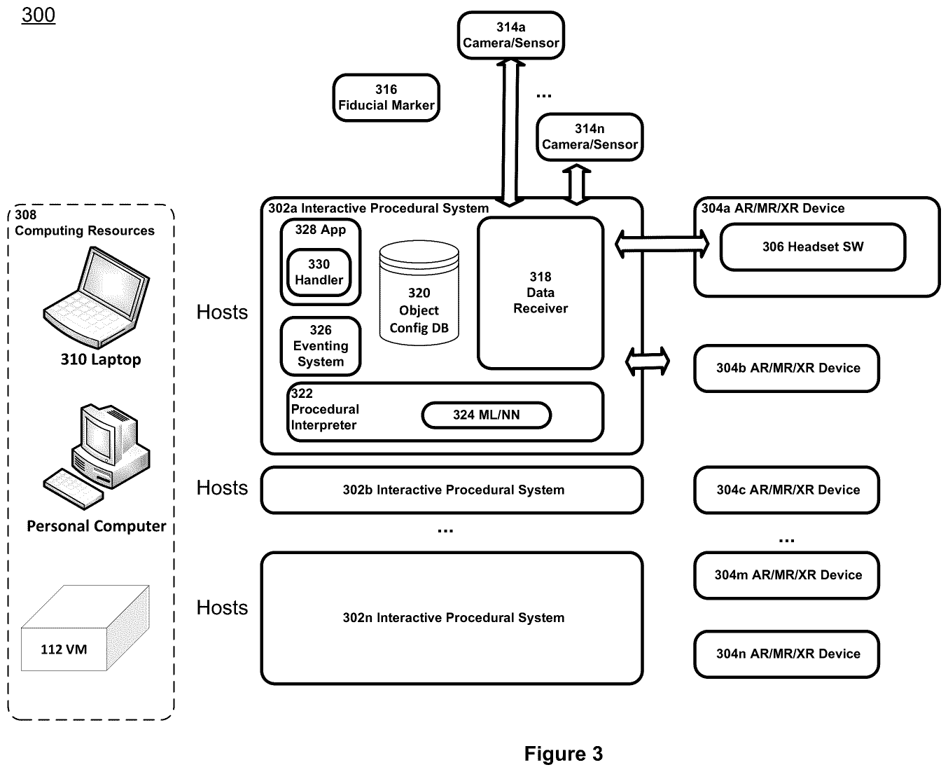

It is useful to describe the improved interactive procedural guidance (IPG) system from a contextual perspective. For purposes of brevity, the terms Interactive Procedural Guidance System or IPG System may refer to the improved system supporting procedural guidance for complex and/or highly sensitive scenarios. FIG. 3 is a contextual diagram 300, of an IPG System 302.

The concept of operations contemplates not just to use one IPG System 302 but potentially a plurality of IPG Systems 302 together with one or more AR/MR/XR devices 304 running client software. In some examples, one IPG system 302 can serve multiple AR/MR/XR devices 304. Specifically, an AR/MR/XR device 304 may be a headset, and an instance of client software 306 may run on the headset itself or on a computing platform such as a laptop 308 or virtual machine 310 hosted on the cloud dedicated to the specific AR/MR/XR device 304. In this way, the AR/MR/XR device 304 and the IPG System 302 in concert may generate precise and spatially accurate information about physical objects in the operator's environment and workspace and spatially accurate generation of virtual objects in the operator's visual and auditory fields.

The IPG System 302 is comprised of both hardware and software. The software may utilize the graphics processor (GPU) of a computing platform and in some cases may use most of its capacity.

The IPG System 302 may utilize one or more video cameras and/or sensors 314. In the case of video cameras 314 the cameras may have the capability to sense depth, for example by being paired with a Time of Flight (ToF) or structured illumination sensor IR sensor, other LIDAR (light detection and ranging), or by a visual stereo camera. These characteristics of the video cameras 314, that may be depth sensing, give the IPG System 302 its enhanced ability to sense and understand physical objects in the sensor's field of view (FoV). In some contexts, one or more of the sensors 314 may refer to any camera or combination of cameras and sensors 314 that can produce images and sense depth. This set of video cameras and sensors 314 enables not just the detection of objects, but also the attitude and/or orientation of those objects.

The IPG System 302 also makes use of computing resources 308. The computing resources 308 may be in the form of a local computing platform such as a laptop 310, or personal computer, having one or more processors including one or more central processing units (CPU) and potentially with one or more GPUs. In some embodiments, the IPG System 302 may be hosted on a virtual machine in the cloud.

The IPG System 302 may carry out key sets of tasks. At a high level, the software analyses information, including image and depth, coming from one or more cameras/sensors either as part of an AR/MR/XR headset 304 or external to the headset in the sensor 314, either by deterministic means, by machine learning means, or any combination thereof. The IPG System 302 establishes a coordinate frame, or Local Coordinate System (LCS) within the sensed volume. Within the sensed volume the software supports identification of physical objects, localizes these objects precisely, determines the poses of physical objects precisely, and tracks the movements of physical objects through space. The software also generates accurately localized and posed virtual objects (visual and auditory) and supports their movement through space and change of pose.

To perform this process, the headset 304 may translate positional and pose information into the Operator's Coordinate System, which is the coordinate frame referenced by the user. In some embodiments, the IPG System 302 may track the distance and pose of AR/MR/XR headsets 304 near it with respect to the LCS coordinates, and transmit all the above information about physical and virtual objects to those headsets, either pre-translated into the coordinate frame of the individual headsets.

In the physical world, the digital twin of the physical world, and the actual virtual world may potentially have different dimensions and behaviors. Furthermore, it may be desirable for different users on different AR/MR/XR headsets 304 to participate in the same virtual space. The IPG System 302 may posit a common coordinate system. The common coordinate system may simply mirror the existing coordinate system, or may make use of linear transforms and translations that map the coordinate systems deterministically to each other. For two-dimensional data, linear transformations and translations in the form of matrices are applied. For three-dimensional data, matrices, tensors, and quaternions (and other vector techniques) may be applied.

Furthermore, corresponding workflow events may be mapped even if the physical configurations of two workspaces are different. For example, if a workflow, as represented by a labeled transition system has different location and/or coordinate in one workspace (i.e., the sulfuric acid is in a flask on the left side of one laboratory bench of a user), as opposed to another workspace (i.e., the sulfuric acid is in a flask on the left side of the laboratory bench of another user), and application 328 may keep track of the different locations, but use machine learning neural net recognition on the different views.

In one embodiment, the IPG System 302 may connect to a single sensor 314 fixed in position, and so collect information from that fixed FoV that defines a subset of the volume accessible by the operator of the AR headset in which spatial resolution is high and spatial localization is accurate. An example of fixing the position of the sensor 314 is to clamp it to a shelf above a working area, or velcroing or taping it to the ceiling of a tissue culture hood. If the operator of the AR device 304 is carrying out procedural work, this volume seen by the sensor's 314 FoV may be referred to as the “working volume” or “workspace”.

More complex implementations may make use of multiple sensors 314 to create larger and or multiple zones of enhanced spatial accuracy or to “clone” instances of the Local Coordinate System and virtual objects within it at remote locations, to generate remote, spatially accurate and highly resolved, “pocket metaverses”.

In some embodiments, the IPG System 302 generates a basis coordinate frame by reference to an optically recognizable fiducial marker 316 such as an ArUCo or ChArUCo card and/or other visually determinable markers. Before use, a process of registration establishes the equivalency of key pixels in image of the fiducial marker, for example using corners of the ChArUCo squares, that are seen both by the IPG System 302 and by the headset camera 304. As needed, a one-time process of calibration of each particular sensor 314 and the cameras used by each AR headset 304 may allow correction for “astigmatism”, any distortions or aberrations, caused, for example, by small imperfections in the camera optics arising during their manufacture. In some implementations, the fiducial marker 316 may be any marker or object that can be detected visually that allow world-locking by the AR headset and alignment of the coordinate frame with that made by the base station.

In practice, the IPG System 302 uses its software to identify physical objects, for example by using a neural network trained to detect the different objects, by operating on pre-existing geometric and feature data about objects, by defining objects as contiguous clumps of depth readings above the plane of the working surface, via detection via clumps of features by an object contrastive network (OCN) via declaration by the operator. It tracks the locations and poses of physical objects, and computes locations of virtual objects within the workspace with respect to the basis coordinate space. It uses information about headset location and pose to translate this information into the coordinate frame of the headset.

There are additional and potentially more complex embodiments. One is that after registration, the IPG System 302 sensor or sensors 304/314 are not fixed, but use optical and other information such as inertial positioning to compute its location and pose with respect to the original basis coordinate system. A second is the use of other objects for fiducial markers 316. A third is that multiple IPG Systems 302, fixed and/or mobile, might define larger working volumes sharing the basis coordinates of a first IPG System 302.

For applications including procedural guidance, a function of the IPG System 302 involves the system supporting object identification, object localization, pose determination, and object tracking, for both physical and virtual objects. It is possible for the headset 304 to carry out one or more of these functions given sufficient processing power. Accordingly, computing workload may be distributed where the constituent computing tasks are divided between the host computing platform 308 (laptop 310 or cloud) and a headset client 314. These entities may communicate over WiFi, using TCP or UDP packets.

Thus far, the use of one or more cameras/sensors, both in the headset 304 and external to the headset 314, including depth capabilities to capture visual information have been described. This information may be collected by the IPG System 302 for performing visual object recognition. Visual object recognition may be performed by a computational engine or by machine learning means. This includes not only visual object recognition of physical objects, but also the attitude and/or orientation of a physical object, the location of a physical object, and the time of capture of a location of a physical object. In some cases, supplementary data, such as audio for a particular time, is also captured. This information is received by a Data Receiver software component 318 and the information is stored by the Data Receiver 318 in an Object Configuration Database 320.

Beyond the identification and tracking of physical objects, the IPG System 302 is able to interpret the visual and supplementary data according to a machine learning neural net configured to recognize procedures. Specifically, a Procedural Interpreter software component 322 interprets the data in the stored Object Configuration Database, and then triggers software events using an Eventing System 326 where configurations are recognized by a machine learning neural net 324. Application 328 in the IPG System 302 that enlist in those software events via the Eventing System 326 may have software handler 330 to create software responses to those events.

For example, in the context of a procedural application 328 involving sulfuric acid, if a flask known to contain sulfuric acid is tilted, the machine learning neural net 326 may recognize a chemical hazard and the Eventing System 326 correspondingly may trigger a software event. An Application 328 being run in the IPG System 302 that enlisted in this software event may then have a software handler 330 that displays a hazard warning to the user, if in fact blocks performing subsequent steps until the hazard recognized by the machine learning neural net 324 is mitigated as recognized by the machine learning neural net 324.

Because the machine learning neural network 324 is interpreting events in the context of a procedure, or workflow, developers can then enlist in events using the context of the procedure to be modeled. Specifically, instead of looking for an event called “ActivateObject”, the event might be contextualized as “DecantFlask.” This may ease software development of applications and ensure that events are not missed due to events being published with generic contexts.

Additionally, note that the application 328 may choose to have the AR/MR/XR device 304 render virtual objects quite differently from the actual dimensions and appearance of the physical object. For example, the physical objects may be rendered with different shapes and sizes. This may be effected by modifying the wireframe for the rendered object to change shape, and modifying the shaders that represent the surface appearance (known colloquially as “skins”) on the wireframe. Reasons to change the shape are manifold, but in one embodiment, it may be desirable to have a flask appear larger in the virtual world such that when the virtual flask collides with another virtual object, in the physical world, the physical flask is smaller and does not in fact collide. This in effect achieves a “safety buffer.” Also, reasons to change the appearance of an object are manifold, but in one embodiment, it may be desirable to highlight or otherwise change the color of an item that is in a hazardous situation, such as red.

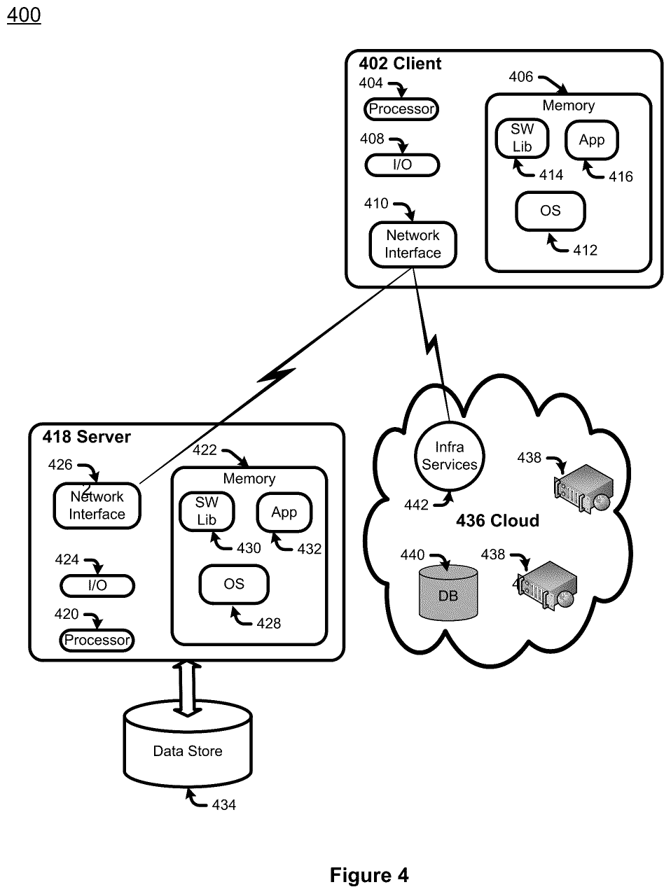

For the context of an Interactive Procedural Guidance System, FIG. 4 describes an environmental diagram 400 that includes an exemplary hardware, software, and communications computing environment. Specifically, the functionality for the Interactive Procedural Guidance System is generally hosted on a computing device. Exemplary computing devices include without limitation personal computers, laptops, embedded devices, tablet computers, smartphones, and virtual machines. In many cases, computing devices are to be networked.

One computing device may be a client computing device 402. The client computing device 402 may have a processor 404 and a memory 406. The processor may be a central processing unit, a repurposed graphical processing unit, and/or a dedicated controller such as a microcontroller. The client computing device 402 may further include an input/output (I/O) interface 408, and/or a network interface 410. The I/O interface 408 may be any controller card, such as a universal asynchronous receiver/transmitter (UART) used in conjunction with a standard I/O interface protocol such as RS-232 and/or Universal Serial Bus (USB). The network interface 410, may potentially work in concert with the I/O interface 408 and may be a network interface card supporting Ethernet and/or Wi-Fi and/or any number of other physical and/or datalink protocols.

Memory 406 is any computer-readable media that may store software components including an operating system 412, software libraries 414, and/or software applications 416. In general, a software component is a set of computer-executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. As defined herein, computer storage media does not include communication media.

A server 418 is any computing device that may participate in a network. The network may be, without limitation, a local area network (“LAN”), a virtual private network (“VPN”), a cellular network, or the Internet. The server 418 is similar to the host computer for the image capture function. Specifically, it may include a processor 420, a memory 422, an input/output interface 424, and/or a network interface 426. In the memory may be an operating system 428, software libraries 430, and server-side applications 432. Server-side applications include file servers and databases including relational databases. Accordingly, the server 418 may have a data store 434 comprising one or more hard drives or other persistent storage devices.

A service on the cloud 436 may provide the services of a server 418. In general, servers may either be a physical dedicated server, or may be embodied in a virtual machine. In the latter case, the cloud 436 may represent a plurality of disaggregated servers that provide virtual application server 438 functionality and virtual storage/database 440 functionality. The disaggregated servers are physical computer servers, which may have a processor, a memory, an I/O interface, and/or a network interface. The features and variations of the processor, the memory, the I/O interface, and the network interface are substantially similar to those described for the server 418. Differences may be where the disaggregated servers are optimized for throughput and/or for disaggregation.

Cloud 436 services 438 and 440 may be made accessible via an integrated cloud infrastructure 442. Cloud infrastructure 442 not only provides access to cloud services 438 and 440 but also to billing services and other monetization services. Cloud infrastructure 442 may provide additional service abstractions such as Platform as a Service (“PAAS”), Infrastructure as a Service (“IAAS”), and Software as a Service (“SAAS”).

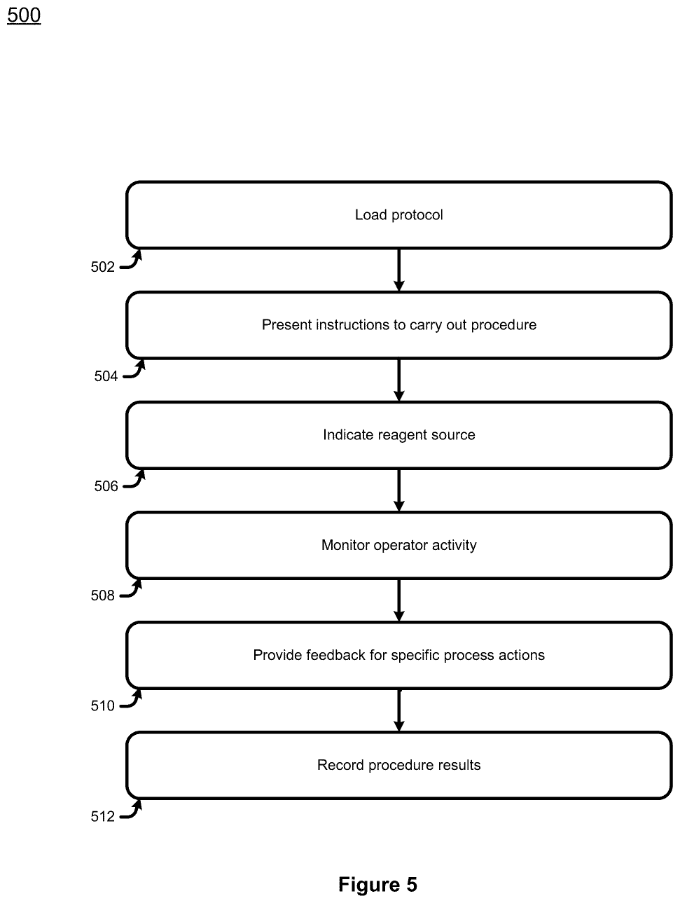

FIG. 5 illustrates an exemplary process 500 for carrying out augmented reality methods as described herein. The process 500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to the environment 100 shown in FIG. 1.

In block 502, the computing system 110 may load the protocol (e.g., the pipetting protocol) into the LabLight system 104. The protocol may be input via a. csv or .xml file, typically generated by a spreadsheet.

At block 504, the LabLight system 104 may present instructions to the operator 102 to carry out the procedure. These instructions may be presented visually and/or audibly via the headset in an AR environment. In some examples, the instructions may take the form of projected words, symbols, images, indicators, etc. presented as overlays over the physical world as viewed through the headset.

At block 506, the LabLight system 104 may provide output to the headset that indicates the source of the subject matter to be moved. For example, the output may be presented by the headset as a visual indicator of a test tube from which a reagent is to be withdrawn using a pipet, as described elsewhere herein.

At block 508, the LabLight system 104 may monitor the activity by the operator 102. The monitoring may include, but is not limited to, determining whether the operator 102 is carrying out the instructions properly and within a specified time or cadence. In some examples, the monitoring may include preventing operator mistakes before they happen, using machine learning models that are trained to detect signs of an imminent error. Geofencing at the bench may be employed to this end.

At block 510, the LabLight system 104 may provide feedback of specific process actions. For example, operator errors may be fed back in real-time, perhaps combined with an instruction to undo and/or repeat a process step. Additionally, or alternatively, feedback may be generated in the form of a log or report, optionally including scoring of the operator.

At block 512, the LabLight system 104 may record the results of the procedure and generate a report.

The systems and techniques described herein may be used for a wide range of applications. By way of example, using the interactive procedural guidance as described herein can enhance the user experience. The context of a chess game may be used to enumerate interactive procedural guidance capabilities and enhancements. As another example that illustrates an additional potential application of those capabilities, the interactive procedural guidance can provide enhancement in the context of laboratory operations. As stated above, these scenarios are merely exemplary and not intended to be limiting.

Turning to the first example, a virtual chess game provides several interactive procedural guidance opportunities for enhancements. Recall that the IPG System described above supports the following capabilities: (1) the capability of rendering artifacts, i.e., creating virtual objects corresponding to physical objects either with high fidelity, both video and audio, or differently, and where rendered differently having the ability to resolve the discrepancies, (2) better recognition of objects, including attitude and orientation, (3) interpretation of the user, workspace, and artifacts within the workspace. For example, some capabilities pertain to suggesting next actions in response to an action taken by the human operator and warning the operator if she is about to make a bad move, and in this way illustrating an interpretation of the configuration of the artifacts by the system. In some cases, the interpretation is performed by a machine learning system such as a trained neural network, which may be trained to interpret chess moves.

A set of potential capabilities made possible by the system include the accurate detection of physical chess pieces by a trained system, not only of the locality of the chess pieces as to be accurate as to their location on a chessboard (or off the board), but also the attitude and orientation such as a piece that has been captured, potentially lying down. Consider the position of a king that is laying down on the board, as being interpretable as the other party resigning from the game. This is affected at least by augmenting the data collected from the workspace using a sensor coupled with a machine learning/neural network that is specific to an application (here chess).

Visual display of virtual chess pieces may have virtual sheathing or skins. This emphasizes that the virtual display of the physical objects themselves need not be the same as in the real world. This can enhance the aesthetics of the pieces, or alternatively enable emphasis (such as illustrating the piece that was just moved). Note that the IPG System can track whether to sheath the physical chess pieces identified by the system with virtual chess pieces either of identical shape and size, or of different shape or size. Note that these differences are to be resolved by the system to detect collisions between virtual objects as opposed to the underlying physical objects, as described elsewhere herein.

Detection of touch by a human operator (human chess player) by a 3-D mask of their hand (think of this as a sheath or skin, generated by a trained system) colliding with the virtual chess piece that sheaths or skins the physical chess piece, supports at least two actions within a chess game: “touching” and “letting go of”. These actions may be interpreted as “picking up” and “putting down.” A consequence is that the IPG System supports software event traps that include context—for example triggering an event on a collision between two masks as opposed to triggering an event on an interpreted touched piece.

A detected action can be used to proceed to the next process step, such as a countermove by the other chess player in this example. Here the application is able to perform this capability by enlisting in an event that represents the detected action.

The IPG System may warn the operator, here a chess player, to help avert imminent errors. Again, the application is able to perform this capability by enlisting in an event that represents the detected action.

The IPG System may specify possible moves an operator may make, here a chess player, touches a piece. In fact, the system may specify better moves than the chess player is considering upon demand. This illustrates contextual procedural guidance. As with the above items, the application is able to perform this capability by enlisting in an event that represents the detected action.

The above set of capabilities is described within the context of a chess game for the purpose of illustration. However, note that in general, if a software handler can be programmed, any response to a recognized event is enabled. Turning to the context of a laboratory scenario, the capabilities of the IPG System and the potential properties enabled by the IPG System may be further illustrated in this context. Note that the term for a class of laboratory procedures or workflows is called a “protocol.”

The IPG System may make use of a particular video lash up to relay headset video to a centralized control monitor function (colloquially known as “mission control”). Mission control may involve a remote user monitoring the user in the AR/MR/XR environment. Alternatively, mission control may involve the remote user broadcasting the experience of the user in the AR/MR/XR environment to others. This may be achieved as follows. First, video for a particular user is captured by the operator's AR device. The Hololens 2™ involves using the front-facing camera using a Microsoft wireless display adapter (meant by Microsoft to be used to mirror monitors). This broadcasts to an HDMI Downsizer (for example from 4K resolution to 1080p) and is captured by a capture card usually on a personal computer. Data from the capture card is operated on by Open Broadcast Studio editing software (“OBS”) at a remote monitoring site, i.e., the “mission control.” OBS may stream the data from the capture card. Then another user at mission control may potentially join a broadcasting software platform such as Microsoft Teams or Zoom, while using their own wireless headphones and microphone and sharing their OBS screen. In this way, third parties may monitor the activity of the user in the AR/MR/XR environment.

The user in the AR/MR/XR environment may make use of various kinds of audio devices to relay audio to mission control including gaming-type wireless headphones. In effect, the wireless headphones are treated as part of the sensor.

The IPG System may generate a floating (relative) checklist and time-stamped checklist, and transmission of the streaming of those checklists to mission control, which records them. In this way, mission control can either monitor or share to third parties the procedure/workflow of the user in the AR/MR/XR environment. The incoming data need not be sensory data, but may be telemetry, or in this case lists.

Laboratory protocol steps may be captured with a machine learning neural network specific to the protocol to enable the IPG System to identify missing objects and or out of order or improperly performed protocol steps. This is a direct emergent property from having a machine learning neural network that is specific to the protocol as loaded and as used to raise events and handle events. Here, the application may choose to create a software handler that displays an “expected objects panel” i.e., a list of objects that are to be detected for a particular protocol step. Example attributes of this expected objects panel may include one or more of:

Displaying a virtual panel that showcases the items required for each step. When an object is detected in the workspace, a label appears above that object, with a countdown indicating it is detected and being confirmed. For example, “confirming” an item may occur if remains present in a scene for a predetermined time, such as five seconds. Once the item is “confirmed” the label has a virtual indicator, for example turning green and rising up and away from the item, fading as it goes. There may also be an audio indicator such as a sound cue being played by the IPG System when an item is confirmed.

Step progression through a protocol is disabled until the items needed for the step are all present and “confirmed.” On the displayed panel of expected objects, a visual artifact may also be provided to provide status. For example, a checkmark may appear next to the confirmed item, or alternatively, the item may be wiped off the list of expected items, leaving behind only the items that are missing on the scene. The IPG System, specifically the machine learning neural network trained on the protocol, may block step progression through the protocol until and unless correct objects are taken and/or are observed. Step progression can be triggered by detected conditions including actions, are halted if actions not taken or objects not detected. Again, this is enabled by the event handling process. In some embodiments, the IPG system may indicate place attention cues, action cues, and aversion cues (such as the virtual cues described elsewhere herein) on or near objects or parts of objects. The IPG system might recognize these objects, and/or parts of objects, by a trained neural network or other computer vision methods. The IPG system might superimpose or place a template or other virtual version of the object (such as a boundary or skin) on the recognized object.

Alternatively, the IPG system might generate a template or other visual representation (e.g., grid or 3D wireframe or 2D “perimeter footprint”) at a designated location within the work volume and prompt the operator to superpose a physical object on the virtual object (or vice versa), and generate attention cues, action cues and aversion cues on parts of the virtual object. In addition, recognizing the object or parts of objects using data from a trained neural network or other computer vision methods, the IPG system may approximately position the template or other virtual representation of the object with respect to the physical object, and prompt the operator to complete the superimposition of the physical object on the virtual one (or vice versa).

Particular actions involving detecting hand activity may include unsupervised training of machine neural networks such as Object Contrastive Networks (OCNs) to recognize distinctive clusters of features including the location of key joints in fingers, hands, and wrists, tracked in time and space (by location in the local coordinate system (LCS)). This is a specialization of having a machine learning neural network specific to the application making use of fine-grained fidelity of interpreting hand movements and gestures. Indeed, neural networks including an OCN can recognize object s and parts of objects, as well as actions, as described herein.

Alternatively, ad hoc methods to detect actions by the IPG System may include detecting the key actions of touching and letting go of by collision of virtual hand sheathed around the physical hand, colliding with virtual sheathing around the touched object, which may be extremely versatile. Again, this is a specialization of having a machine learning neural network specific to the application making use of fine-grained fidelity of interpreting hand movements and gestures.

In some embodiments, effects of system improvements on operator performance can be evaluated by A/B testing. For example, to monitor operator performance, different volumes of solution that contains a fluorophore may be loaded into different wells. The fluorophore solutions can have fluorophores that emit light of different colors (e.g., green and red) that can be excited by light of a shorter wavelength band. The fluorophores used do not need to be visible in normal light. Their emissions can be read on a common lab instrument, a fluorimeter that can measure the amount of light emitted in different wavelength bands from the different wells in the dish. In a actual assay, high (20), medium (8 or 7) and low (2 Au) concentrations of a single fluorophore, fluorescein, were used, for which the amount of signal emitted from a constant volume (10 μL) of those different concentration solutions allowed a determination without ambiguity as to which and whether a well was loaded with High, Medium, and Low, or with two separate shots and so combines shots that combined two concentrations (H+L, H+M, etc.). This enables a determination as to whether a well was skipped, the wrong well was loaded, etc. In other experiments data has been combined from two different fluorophores, red and green. Data from a text file from the machine was ingested into a Python program that scored it and generated a .csv or .xml file that is output as a spreadsheet.

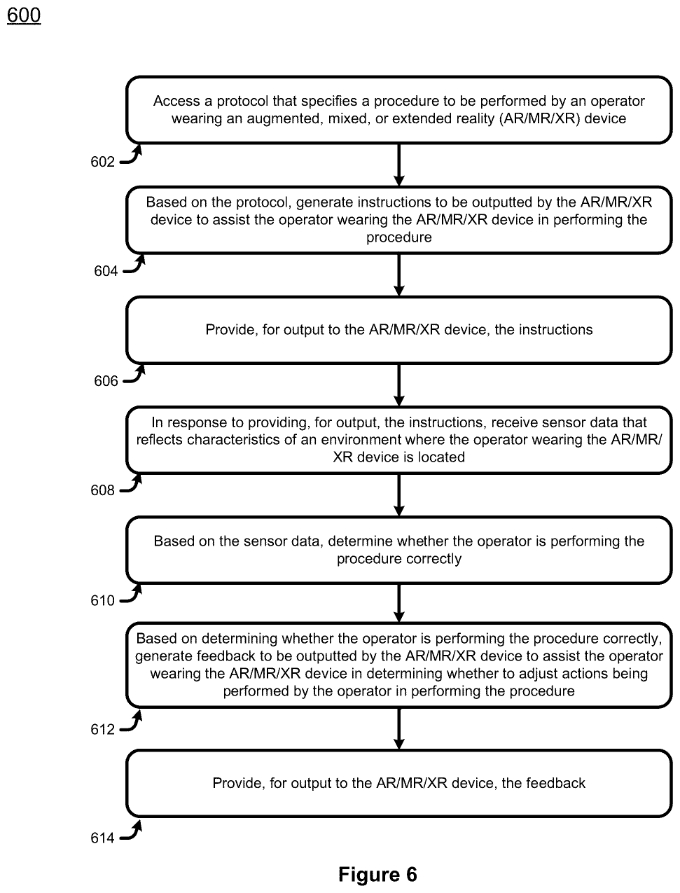

FIG. 6 is a flowchart of another exemplary process for carrying out, for example, lab work guided by augmented reality methods. In general, the process 600 access a protocol for a procedure to be carried out by an operator. The process 600 generates instructions to perform the procedure and outputs the instructions to an AR/MR/XR device. The process 600 receives sensor data of the environment. Based on the sensor data, the process 600 determines whether the operator is performing the procedure correctly and provides feedback to the AR/MR/XR device. The process 600 will be described as being performed by the interactive procedural system 302 of FIG. 3 and will include references to other components in FIG. 3. In some implementations, the process 600 may be performed by one or more components illustrated in FIGS. 1, 2, and/or 4. In some implementations, the process 600 may be performed by one or more computing devices, including virtual computing devices.

The interactive procedural system 302 accesses a protocol that specifies a procedure to be performed by an operator wearing an augmented, mixed, or extended reality (AR/MR/XR) device 304 (602). In some implementations, the procedure may be a laboratory procedure that involved mixing various chemicals in microplates trays or other types of wells using various types of pipets. In some implementations, the procedure may be to play a game, such as chess. In some implementations, the protocol may be included in a file. For example, the file may be a csv file, an xml file, and/or an xmlx file. As another example, the file may be a spreadsheet file. In some implementations, the AR/MR/XR device 304 is a headset, glasses, goggles, contact lenses, and/or any other similar type of device that can perform augmented, mixed, or extended reality.

Based on the protocol, the interactive procedural system 302 generates instructions to be outputted by the AR/MR/XR device to assist the operator wearing the AR/MR/XR device 304 in performing the procedure (604). In some implementations, these instructions may include text and/or images to be included in the AR/MR/XR device 304. The text and/or images may be overlaid onto the field of view of the operator who is wearing the AR/MR/XR device 304. The instructions may include data identifying a physical object where the text and/or images may be presented. For example, the image may be an arrow and may include instructions to point the arrow at a particular well in the microplate. As another example, the image may be a chess piece and may illustrate the suggested movement of a chess piece where the movement originates at the current location of the chess piece.

The interactive procedural system 302 provides, for output to the AR/MR/XR device 304, the instructions (606). As noted above, the instructions include images and/or text to present to the operator through the AR/MR/XR device 304. The instructions may also identify one or more objects to which the text and/or images should be linked. The instructions may also identify how the objects should be identified. For example, the identification instructions may include references to fixed markers 316 on the microplate that allows the identification of a corner of the microplate.

In response to providing, for output, the instructions, the interactive procedural system 302 receives sensor data that reflects characteristics of an environment where the operator wearing the AR/MR/XR device 304 is located (608). In some implementations, the sensor data may be generated by sensors 314 that include a camera, a time of flight sensor, a structured illumination sensor, an infrared sensor, a light detection and ranging scanner, a proximity sensor, a microphone, a gyroscope, an accelerometer, a proximity sensor, a gravity sensor, a thermometer, a humidity sensor, a magnetic sensor, a pressure sensor, a capacitive sensor, and/or any other similar type of sensor. In some implementations, a combination of sensors may be configured to sense depth in the field of view of the AR/MR/XR device 304. In some implementations, the sensors 314 may be integrated into the AR/MR/XR device 304. In some implementations, the sensors 314 are separate from the AR/MR/XR device 304 and integrated with an object the may be movable or fixed into place. In some implementations, the sensors 314 are separate from the AR/MR/XR device 304 and integrated with an object manipulated by the operator during performance of the procedure. For example, the sensors 314 may be integrated with a pipet tool and/or gloves of the operator.

In some implementations, the sensors may generate sensor data and transmit the sensor data to the interactive procedural system 302 at a periodic interval, such as every minute. In some implementations, the sensors may generate the sensor data in response to a request from the interactive procedural system 302. In some implementations, the sensors may generate the sensor data based on the sensor data changing a threshold amount or a threshold percentage.

The interactive procedural system 302 may analyze the sensor data in the process of performing some of the features described above. In some implementations, the interactive procedural system 302 may analyze the sensor data before selecting the protocol. This may be the case if the operator starts performing various actions but has not provided an indication as to the protocol that the operator is performing. Based on the analysis of the sensor data, the interactive procedural system 302 may automatically determine a procedure that the operator is performing. In this case, the interactive procedural system 302 may automatically identify the corresponding protocol and load that protocol. Based on analyzing the sensor data and the procedure of the protocol, the interactive procedural system 302 may determine the stage in the procedure where the operator is. The interactive procedural system 302 may begin generating and providing instructions to the AR/MR/XR device 304 that align with the stage in the procedure where the operator is.

In some implementations, the interactive procedural system 302 may analyze the sensor data as part of the generation of the instructions provided to the AR/MR/XR device 304. Based on the analysis of the sensor data, the interactive procedural system 302 may select a step of the procedure and generate instructions based on that step. For example, the operator may speak a command that indicates the stage of the procedure that the operator is about to perform, is performing, or performed. The interactive procedural system 302 may receive the corresponding audio data, compare the audio data to known commands, and update the stage of the procedure accordingly. In some implementations, the speech of the operator may not match any of the known commands. In this case, the interactive procedural system 302 may output a request for the operator to speak a different command, output a list of the known commands, and/or use the audio data and/or other sensor data to determine the likely stage of the procedure. For example, the interactive procedural system 302 may analyze the audio data and/or other sensor data and determine the stage without and audio command from the operator. The interactive procedural system 302 may then generate and output instructions corresponding to the identified stage.

Based on the sensor data, the interactive procedural system 302 determines whether the operator is performing the procedure correctly (610). In some implementations, the interactive procedural system 302 may determine that there is a change in a location of an object within a field of view of the operator wearing the AR/MR/XR device. In this case, the object may be one that is part of the procedure. The interactive procedural system 302 may compare the change in the location of the object to the protocol. If the change in the location matches what is specified by the protocol, then the interactive procedural system 302 may determine that the operator is performing the procedure correctly. If the change in the location does not match what is specified by the protocol, then the interactive procedural system 302 may determine that the operator is performing the procedure incorrectly.

In some implementations, the interactive procedural system 302 may determine that there is a change in a pose of an object. In this case, the object may be one that is part of the procedure. The interactive procedural system 302 may compare the change in the pose of the object to the protocol. If the change in the pose matches what is specified by the protocol, then the interactive procedural system 302 may determine that the operator is performing the procedure correctly. If the change in the pose does not match what is specified by the protocol, then the interactive procedural system 302 may determine that the operator is performing the procedure incorrectly.

In some implementations, the interactive procedural system 302 may determine that there is a change in the distance between an object and the AR/MR/XR device 304. In this case, the object may or may not be one that is part of the procedure. The object may be used to help determine the location of the operator. The interactive procedural system 302 may compare the change in the distance to the protocol. If the change in the distance matches what is specified by the protocol, then the interactive procedural system 302 may determine that the operator is performing the procedure correctly. If the change in the distance does not match what is specified by the protocol, then the interactive procedural system 302 may determine that the operator is performing the procedure incorrectly.

In some implementations, the interactive procedural system 302 may determine that there is a change in the distance between an object and another object. In this case, either of the objects may or may not be part of the procedure. The interactive procedural system 302 may compare the change in the distance between the objects to the protocol. If the change in the distance matches what is specified by the protocol, then the interactive procedural system 302 may determine that the operator is performing the procedure correctly. If the change in the distance does not match what is specified by the protocol, then the interactive procedural system 302 may determine that the operator is performing the procedure incorrectly.

Based on determining whether the operator is performing the procedure correctly, the interactive procedural system 302 generates feedback to be outputted by the AR/MR/XR device 304 to assist the operator in determining whether to adjust actions being performed by the operator in performing the procedure (612).

In some implementations, the interactive procedural system 302 determines that the operator is performing the procedure correctly. In this case, the interactive procedural system 302 may generate feedback that consists of an image and/or audio that indicates the operator is performing the procedure correctly. For example, the image may be a checkmark, the removal of an instruction that the operator performed, and/or any other similar image. As another example, the audio may be audio data confirming the procedure or portion of the procedure was performed correctly. The feedback may also indicate a location for the image. For example, the image may be overlaid on a particular object when the object is within the field of view of the operator.

In some implementations, the interactive procedural system 302 determines that the operator is performing the procedure incorrectly. In this case, the interactive procedural system 302 may generate feedback that consists of an image and/or audio that indicates the operator is performing the procedure incorrectly. For example, the image may be an x, a highlighting of the instruction performed incorrectly, instructions to correct the mistake, graphics to guide the operator to correct the mistake, and/or any other similar image. As another example, the audio may be audio data indicating the procedure or portion of the procedure was performed incorrectly. The feedback may also indicate a location for the image. For example, the image may be overlaid on a particular object when the object is within the field of view of the operator. The interactive procedural system 302 may maintain the error images or audio until the error is corrected. At that point, the interactive procedural system 302 may update the images or audio to indicate correction of the mistake.

The interactive procedural system 302 provides, for output to the AR/MR/XR device, feedback (614). The AR/MR/XR device may display the feedback according to the instructions included in the feedback. For example, the instructions may indicate to overlay an image on a particular object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
accessing, by an interactive procedural system, a protocol that specifies a procedure to be performed by an operator wearing an augmented, mixed, or extended reality (AR/MR/XR) device;
based on the protocol, generating, by the interactive procedural system, instructions to be outputted by the AR/MR/XR device to assist the operator in performing the procedure;
providing, for output by the interactive procedural system and to the AR/MR/XR device, the instructions;
in response to providing, for output, the instructions, receiving, by the interactive procedural system, sensor data that reflects characteristics of an environment where the operator wearing the AR/MR/XR device is located;
based on the sensor data, determining, by the interactive procedural system, whether the operator is performing the procedure correctly;
based on determining whether the operator is performing the procedure correctly, generating, by the interactive procedural system, feedback to be outputted by the AR/MR/XR device to assist the operator in determining whether to adjust actions being performed by the operator in performing the procedure; and
providing, for output by the interactive procedural system and to the AR/MR/XR device, the feedback.

2. The method of claim 1, wherein:
determining whether the operator is performing the procedure correctly comprises determining that the operator is performing the procedure correctly, and
generating the feedback comprises:
generating a visual indicator that indicates that the operator is performing the procedure correctly;
identifying a physical object in the environment where the operator wearing the AR/MR/XR device is located; and
generating instructions to augment the physical object while the physical object is in the field of view of the operator wearing the AR/MR/XR device.

3. The method of claim 1, wherein:
determining whether the operator is performing the procedure correctly comprises determining that the operator is performing the procedure incorrectly, and
generating the feedback comprises:
generating a first visual indicator that indicates that the operator is performing the procedure incorrectly;
identifying a first physical object (i) in the environment where the operator wearing the AR/MR/XR device is located and (ii) where an incorrect performance of the procedure occurred;
generating a second visual indicator;
identifying a second physical object (i) in the environment where the operator wearing the AR/MR/XR device is located and (ii) where a correction to the incorrect performance should occur; and
generating first instructions to augment the first physical object while the first physical object is in the field of view of the operator wearing the AR/MR/XR device and second instructions to augment the second physical object while the second physical object is in the field of view of the operator wearing the AR/MR/XR device.

4. The method of claim 1, wherein the sensor data are generated by sensors that (i) comprise a camera, a time of flight sensor, a structured illumination sensor, an infrared sensor, a microphone, and a light detection and ranging scanner, (ii) that are integrated with the AR/MR/XR device, (iii) that are separate from the AR/MR/XR device and integrated with a fixed object, and (iv) that are separate from the AR/MR/XR device and integrated with an object manipulated by the operator during performance of the procedure.

5. The method of claim 1, wherein a format of the protocol is a csv, xml, or xmlx format.

6. The method of claim 1, wherein generating the instructions to be outputted by the AR/MR/XR device to assist the operator in performing the procedure:
receiving additional sensor data that reflects additional characteristics of the environment where the operator wearing the AR/MR/XR device is located;
based on the additional sensor data, selecting a step of the procedure; and
based on the step of the procedure, generating the instructions.

7. The method of claim 6, wherein the additional sensor data is audio data.

8. The method of claim 7, wherein selecting the step of the procedure comprises:
determining a spoken term included in the audio data;
comparing the spoken term to a set of terms;
determining that the spoken term corresponds to a term of the set of terms; and
selecting the step of the procedure based on the term of the set of terms.

9. The method of claim 1, wherein determining whether the operator is performing the procedure correctly comprises:
analyzing the sensor data;
based on analyzing the sensor data, determining (i) a change in a location of an object within a field of view of the operator wearing the AR/MR/XR device, (ii) a change in a pose of the object, (iii) a change in a distance between the object and the AR/MR/XR device, or (iv) a change in a distance between the object and an additional object; and
determining whether the operator is performing the procedure correctly based on (i) the change in the location of the object within the field of view of the operator wearing the AR/MR/XR device (ii) the change in the pose of the object, (iii) the change in the distance between the object and the AR/MR/XR device, or (iv) the change in the distance between the object and an additional object.

10. The method of claim 1, comprising:
receiving additional sensor data that reflects additional characteristics of the environment where the operator wearing the AR/MR/XR device is located; and
based on the additional sensor data, determining the procedure being performed by the operator,
wherein accessing the protocol is based on determining the procedure being performed by the operator wearing the AR/MR/XR device.

11. A system, comprising:
one or more processors; and
memory including a plurality of computer-executable components that are executable by the one or more processors to perform a plurality of acts, the plurality of acts comprising:
accessing a protocol that specifies a procedure to be performed by an operator wearing an augmented, mixed, or extended reality (AR/MR/XR) device;
based on the protocol, generating instructions to be outputted by the AR/MR/XR device to assist the operator in performing the procedure;
providing, for output to the AR/MR/XR device, the instructions;
in response to providing, for output, the instructions, receiving sensor data that reflects characteristics of an environment where the operator wearing the AR/MR/XR device is located;
based on the sensor data, determining whether the operator is performing the procedure correctly;
based on determining whether the operator is performing the procedure correctly, generating feedback to be outputted by the AR/MR/XR device to assist the operator in determining whether to adjust actions being performed by the operator in performing the procedure; and
providing, for output to the AR/MR/XR device, the feedback.

12. The system of claim 11, wherein:
determining whether the operator is performing the procedure correctly comprises determining that the operator is performing the procedure correctly, and
generating the feedback comprises:
generating a visual indicator that indicates that the operator is performing the procedure correctly;
identifying a physical object in the environment where the operator wearing the AR/MR/XR device is located; and
generating instructions to augment the physical object while the physical object is in the field of view of the operator wearing the AR/MR/XR device.

13. The system of claim 11, wherein:
determining whether the operator is performing the procedure correctly comprises determining that the operator is performing the procedure incorrectly, and
generating the feedback comprises:
generating a first visual indicator that indicates that the operator is performing the procedure incorrectly;
identifying a first physical object (i) in the environment where the operator wearing the AR/MR/XR device is located and (ii) where an incorrect performance of the procedure occurred;
generating a second visual indicator;
identifying a second physical object (i) in the environment where the operator wearing the AR/MR/XR device is located and (ii) where a correction to the incorrect performance should occur; and
generating first instructions to augment the first physical object while the first physical object is in the field of view of the operator wearing the AR/MR/XR device and second instructions to augment the second physical object while the second physical object is in the field of view of the operator wearing the AR/MR/XR device.

14. The system of claim 11, wherein the sensor data are generated by sensors that (i) comprise a camera, a time of flight sensor, a structured illumination sensor, an infrared sensor, a microphone, and a light detection and ranging scanner, (ii) that are integrated with the AR/MR/XR device, (iii) that are separate from the AR/MR/XR device and integrated with a fixed object, and (iv) that are separate from the AR/MR/XR device and integrated with an object manipulated by the operator during performance of the procedure.

15. The system of claim 11, wherein a format of the protocol is a csv, xml, or xmlx format.

16. The system of claim 11, wherein generating the instructions to be outputted by the AR/MR/XR device to assist the operator in performing the procedure:
receiving additional sensor data that reflects additional characteristics of the environment where the operator wearing the AR/MR/XR device is located;
based on the additional sensor data, selecting a step of the procedure; and
based on the step of the procedure, generating the instructions.

17. The system of claim 16, wherein:
the additional sensor data is audio data, and
selecting the step of the procedure comprises:
determining a spoken term included in the audio data;
comparing the spoken term to a set of terms;
determining that the spoken term corresponds to a term of the set of terms; and
selecting the step of the procedure based on the term of the set of terms.

18. The system of claim 11, wherein determining whether the operator is performing the procedure correctly comprises:
analyzing the sensor data;
based on analyzing the sensor data, determining (i) a change in a location of an object within a field of view of the operator wearing the AR/MR/XR device, (ii) a change in a pose of the object, (iii) a change in a distance between the object and the AR/MR/XR device, or (iv) a change in a distance between the object and an additional object; and
determining whether the operator is performing the procedure correctly based on (i) the change in the location of the object within the field of view of the operator wearing the AR/MR/XR device (ii) the change in the pose of the object, (iii) the change in the distance between the object and the AR/MR/XR device, or (iv) the change in the distance between the object and an additional object.

19. The system of claim 11, wherein the plurality of acts comprise:
receiving additional sensor data that reflects additional characteristics of the environment where the operator wearing the AR/MR/XR device is located; and
based on the additional sensor data, determining the procedure being performed by the operator,
wherein accessing the protocol is based on determining the procedure being performed by the operator wearing the AR/MR/XR device.

20. One or more non-transitory computer-readable media storing computer-executable instructions that upon execution cause one or more computers to perform acts comprising:
accessing a protocol that specifies a procedure to be performed by an operator wearing an augmented, mixed, or extended reality (AR/MR/XR) device;
based on the protocol, generating instructions to be outputted by the AR/MR/XR device to assist the operator in performing the procedure;
providing, for output to the AR/MR/XR device, the instructions;
in response to providing, for output, the instructions, receiving sensor data that reflects characteristics of an environment where the operator wearing the AR/MR/XR device is located;
based on the sensor data, determining whether the operator is performing the procedure correctly;
based on determining whether the operator is performing the procedure correctly, generating feedback to be outputted by the AR/MR/XR device to assist the operator in determining whether to adjust actions being performed by the operator in performing the procedure; and
providing, for output to the AR/MR/XR device, the feedback.
